(19) United States
(12) Patent Application Publication
(10) Pub. No.: US 2006/0020509 A1
(43) Pub. Date: Jan. 26, 2006

(54) System and method for evaluating and managing the productivity of employees

(75) Inventors: Joseph A. Strain, Coppell, TX (US); Todd G. White, Allen, TX (US)

Correspondence Address: BAKER BOTTS L.L.P., 2001 ROSS AVENUE, SUITE 600, DALLAS, TX, 75201-2980, US

(73) Assignee: SOURCECORP INCORPORATED

(21) Appl. No.: 10/901,256

(22) Filed: Jul. 26, 2004

(51) Int. Cl. G06Q 30/00

(52) U.S. Cl. 705/14

(57) ABSTRACT

According to one embodiment of the invention, a computerized method for evaluating and managing employees includes storing historical production data and historical quality data for a plurality of tasks, determining benchmark production data and benchmark quality data for a first task based on at least some of the historical production data and historical quality data, receiving current production data and current quality data for a plurality of employees for the first task, comparing the current production data to the benchmark production data for the first task to determine an efficiency of each employee, comparing the current quality data to the benchmark quality data for the first task to determine a quality of each employee, and determining an incentive for each employee for the first task based on the efficiency and the quality for each employee.

### TECHNICAL FIELD OF THE INVENTION

This invention relates in general to evaluation and management of employees and, more particularly, to a system and method for evaluating and managing the productivity of employees.

### BACKGROUND OF THE INVENTION

Outsourcing is a process by which a company arranges for a third party to implement and/or manage a specific department or business process of the company. One reason for outsourcing is that the company lacks in-house resources or expertise to handle a particular business process. Cost may also be a factor along with the inability to handle new technologies. Companies that provide outsourcing services may have hundreds or even thousands of employees that perform many different types of tasks, depending on the type of work being outsourced. Managing and evaluating these employees can be a major undertaking. In addition, responding to proposals and scheduling considerations may also be difficult.

### SUMMARY OF THE INVENTION

According to one embodiment of the invention, a computerized method for evaluating and managing employees includes storing historical production data and historical quality data for a plurality of tasks, determining benchmark production data and benchmark quality data for a first task based on at least some of the historical production data and historical quality data, receiving current production data and current quality data for a plurality of employees for the first task, comparing the current production data to the benchmark production data for the first task to determine an efficiency of each employee, comparing the current quality data to the benchmark quality data for the first task to determine a quality of each employee, and determining an incentive for each employee for the first task based on the efficiency and the quality for each employee.

Some embodiments of the invention provide a number of technical advantages. Certain embodiments of the invention may include all, some, or none of these advantages. In one embodiment, an employee management application analyzes production transaction data, quality sampling data, and internal historical benchmarking in a set of mathematical processes. In some embodiments, the application is a solution for production shop management including, but not limited to, tracking production and quality statistics, work force scheduling, tracking, calculating, and paying incentives, and pricing and supporting customer proposals. The application may systematically calculate standard production rates for historical work performed or calculate average rates for production teams based on historical data, both flat average and average-weighted by production volume.

In other embodiments, a performance reporting tool uses standard rates and lapsed time to measure productivity in efficiency percentages, which are independent of type of work being done. This allows comparisons between work of dissimilar types. A performance plan tool creates performance plans based on an efficiency percentage and a quality percentage per worker and allows payments to be based on productive time; pieces produced, or pieces produced above a standard. An automated import tool may be utilized for loading production data from other applications or databases. In addition, data management schema may lock down past period data, isolating it from adjustments and updates, and allowing regeneration of past payments. The employee management application may also have the ability to schedule teams against defined delivery schedules based on the historical performance of the team members.

Other technical advantages will be readily apparent to one skilled in the art from the following figures, descriptions, and claims.

### BRIEF DESCRIPTION OF THE DRAWINGS

For a more complete understanding of the present invention and for further features and advantages, reference is now made to the following description, taken in conjunction with the accompanying drawings, in which:

FIG. 1 is a block diagram of a computer system storing an employee management application for use in carrying out one embodiment of the present invention;

FIG. 2 is a functional block diagram of an employee management application according to one embodiment of the present invention;

FIG. 3 is a flowchart illustrating an example method of evaluating and managing employees according to one embodiment of the present invention; and

FIG. 4 is a chart illustrating a performance plan for a task according to one embodiment of the present invention.

### DETAILED DESCRIPTION OF THE DRAWINGS

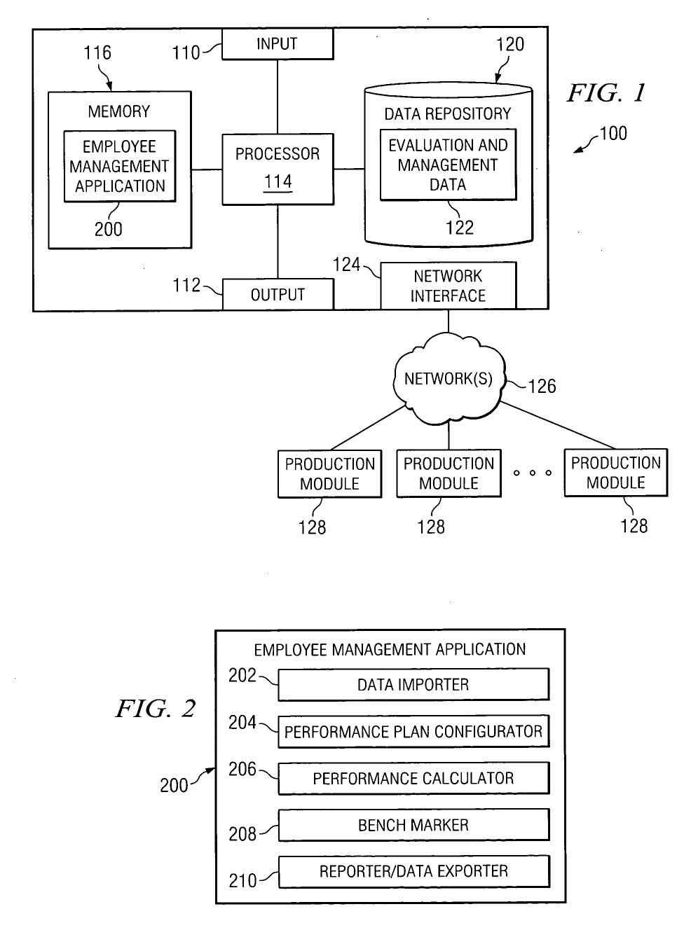

Example embodiments of the present invention and their advantages are best understood by referring now to FIGS. 1 through 4 of the drawings, in which like numerals refer to like parts.

FIG. 1 is a block diagram of computer system 100 for use in evaluating and managing employees according to one embodiment of the present invention. In the illustrated embodiment, computer system 100 includes an input device 110, an output device 112, a processor 114, a memory 116 storing employee management application 200, a data repository 120 storing evaluation and management data 122, and a network interface 124 that couples to one or more networks 126.

Input device 110 is coupled to computer system 100 for allowing a user to execute employee management application 200. In one embodiment, input device 110 may be a keyboard; however, input device 110 may take other suitable forms including, but not limited to, a mouse, a stylus, a scanner, or any combination thereof. Output device 112 may be any suitable visual display unit, such as a liquid crystal display (“LCD”) or cathode ray tube (“CRT”) display, for example, that facilitates visualization of information relating to employee management application 200. Output device 112 may also be a printer for the purpose of printing any desired information. Information and data may also be sent to a storage location, such as data repository 120, or sent to and utilized by another computer program.

Processor 114 comprises any suitable type of processing unit that executes logic. One of the functions of processor 114 is to retrieve employee management application 200 from memory 116 and execute employee management application 200 to allow a user to evaluate and manage employees. Other functions of employee management application 200 are discussed more fully below in conjunction with FIGS. 2 through 4. Processor 114 may also control the receiving and/or storing of information and other suitable data, such as historical and current production and quality data as further described below.

Employee management application 200 is a computer program or set of computer programs written in any suitable computer language. According to the teachings of one embodiment of the invention, employee management application 200 is a .NET browser-based enterprise business application. One example function is to provide an employee productivity management system for document imaging, scanning, and data entry business process outsourcing (“BPO”) operations.

In one embodiment, employee management application 200 permits operations management to track employee productivity, balance that productivity against quality levels, establish performance benchmarks for specific types of tasks, and establish incentives for employees that are consistent with business objectives and direct labor cost allowances on customer jobs. Employee management application 200 may also provide a fair and consistent set of standards for paying employees either piece rate pay or base pay plus incentive for task performed, independent of the type of task performed. Employee management application 200 may be flexible enough to accommodate many different operating companies and data interfaces with many different types of existing production equipment. Employee management application 200 may perform other suitable functions, some of which are described below in conjunction with FIGS. 2 through 4. In the illustrated embodiment, employee management application 200 is logic encoded in memory 116. However, in alternative embodiments, employee management application 200 is implemented through application specific integrated circuits (“ASICs”), field programmable gate arrays (“FPGAs”), digital signal processors (“DSPs”), or other suitable specific or general purpose processors.

Memory 116 and data repository 120 may comprise files, stacks, databases, or other suitable organizations of volatile or nonvolatile memory. Memory 116 and data repository 120 may be random-access memory, read-only memory, CD-ROM, removable memory devices, or any other suitable devices that allow storage and/or retrieval of data. Memory 116 and data repository 120 are interchangeable and may perform the same functions. In the illustrated embodiment, data repository 120 stores evaluation and management data, such as production and quality data, performance plans, employee data, job and task data, and other suitable information that allows a user to execute employee management application 200 when evaluating and managing employees.

Network interface 124, in one embodiment, is a network interface card; however, network interface 124 may be other devices suitable for transmitting and receiving signals to and from network 126, such as a modem. Network 126 may be any suitable wireline or wireless network, such as the Internet, an extranet, an intranet, a virtual private network, or other suitable network or multiple networks. For example, network 126 may be a private network of a corporation, such as a local area network or a wide area network. In the illustrated embodiment, network 126 couples to a plurality of modules 128 that may or may not be geographically distributed. Modules 128 represent any suitable software applications that possess information and data useful to employee management application 200, as further described below. As one example, a particular module may be a statistical application that captures production and quality data for particular task of a particular job.

FIG. 2 is a functional block diagram of employee management application 200. In the illustrated embodiment, employee management application 200 includes five functional components: a data importer 202, a performance plan configurator 204, a performance calculator 206, a benchmarker 208, and a reporter/data exporter 210. The present invention contemplates employee management application 200 having fewer, more, or different functional components than those shown in FIG. 2.

Data importer 202 generally functions to receive and store data in data repository 120 (FIG. 1). The data may be received from any suitable source, such as modules 128 or users that input the data manually. Data may also be in any suitable format, such as XML, so that several types of data may be received by data importer 202. Some examples of the type of data are current production data, current quality data, employee data, customer data, job and task data, and performance plans.

Current production data may be received from any suitable scanning, image, capture, and data entry systems. The current production data may identify the employee that did the work, the job type that the work was performed on, the task type that the employee was performing, the elapsed time for the task to be completed, and the unit of work produced, such as images scanned, number of keystrokes, etc.

Current quality data may be received from an external quality control module or may be manually entered into employee management application 200 by users. In one embodiment, the current quality data identifies the employee, job type, size of sampling, number of errors in sampling, and severity of each error. Other suitable quality information may be associated with current quality data.

Employee data may include employee demographics or identification data and may be received from either production modules or from a suitable Time and Attendance system or payroll system. The demographics data may identify each employee by unique id number, badge number, team, and job location.

Customer data may includes customer ID, name, address, and other suitable descriptive information. Job data may be a listing of jobs that are associated with a particular customer, and job task data are valid tasks assigned to particular jobs. Each task is attached to a particular job and, in one embodiment, includes a unit of measure for productivity, a target unit of work, a time frame, effective date for the task, quality type, and user identification and time stamps.

Other types of data that data importer 202 may receive and store in data repository 120 are benchmark production data and benchmark quality data, performance plans such as incentive grids, error types, ramp factor tables, trend reports, and other suitable types of data.

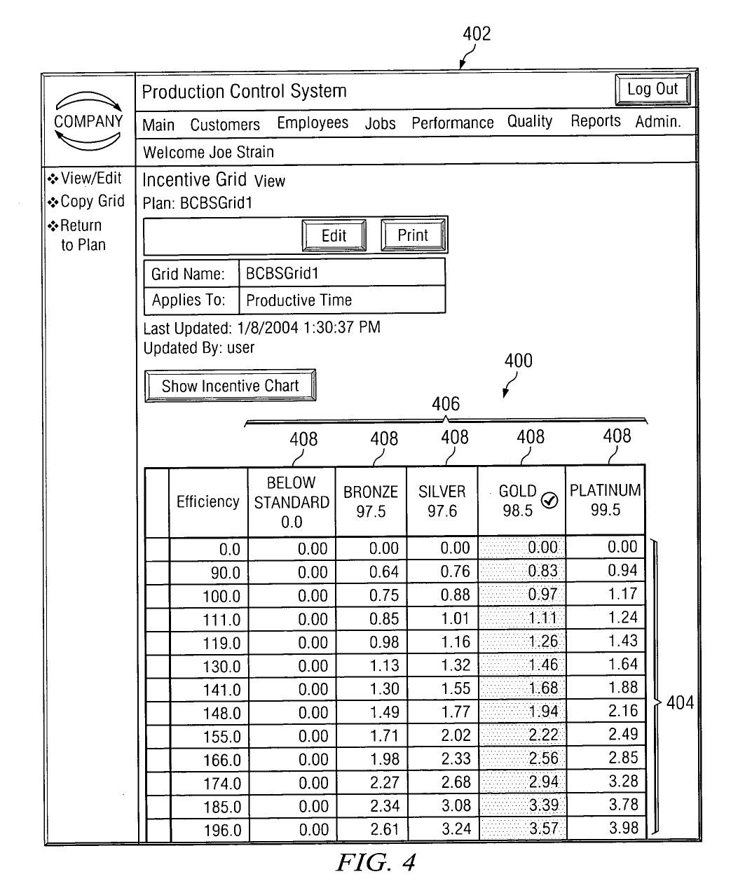

Performance plan configurator 204, in one embodiment, is an administrator-level module that allows sites to configure site-specific performance plans. Performance plan configurator 204 provides functionality for allowing a plan to be established for incentive-based compensation and employee or job productivity evaluation, for example. If the usage at a site is for incentive-based pay, for example, the system may allow for definition of the criteria for calculating the incentive structure. Performance plans, an example of which is shown and described in FIG. 4, may be based on efficiency percentage and quality percentage per employee.

Performance plan configurator 204 may also store job tasks and their expected performance standards or benchmarks. Performance plan configurator 204 may permit managers to run “what if” pay scenarios using real data. For example, it may allow for preview calculations based on a select base of a users performance or configured test data. In one embodiment, after data importer 202 has captured current production and quality data for a particular job, the performance plan configurator 204 receives historical data from benchmarker 208 (described below) to reset pay structures based on the current production data and current quality data.

Performance calculator 206 is a module that performs statistical functions and returns employee evaluation and management data. In one embodiment, performance calculator 206 uses a performance plan and operational statistics generated according to data from data repository 120 (FIG. 1) to determine incentives for employees. This module of employee management application 200 may store information on the production target for each task worked for each employee. This allows payments to be based on productive time, pieces produced, pieces produced above a standard, or other suitable criteria.

In one embodiment, a process of performing an employee evaluation includes comparing current production and quality data against pre-established benchmark production and quality data. The following table is an example of driving factors for their respective services.

| Service | Throughout Productivity Driver | Quality Detractors |
|---|---|---|
| Doc. Prep | Boxes, Batches, Documents, Pages, | Rescans |
| | Hours | Breakdowns |
| Scanning | Boxes, Batches, Documents, Pages, | Rescans |
| | Hours | Breakdowns |
| Data Entry | Gross Key, Net Key, Documents, | Double Key Fixes |
| | Pages, Hours | Audit Errors |

To establish production targets, performance calculator 206 may exclude predetermined top end and bottom end performance data when calculating a target rate of throughput per hour to reduce statistical skewing. For example, for Data Entry, the following table represents a subset of the summary performance calculation data that might be stored by performance calculator 206:

| | | | | Bill | Bill- | |
|---|---|---|---|---|---|---|
| | | Keystroke | Keystroke | Rate | ing | Target |
| | Applica- | Bench- | Per Clock | Per | Hrly | Labor |
| Code | tion | mark | Hr | Keys | Rate | Rate |
| ADV | Credit | 6300 | 6300 | 0.00457 | $28.8 | $8.5 |
| | Apps | | | | | |
| Amer | Stud Files | 7000 | 7000 | 0.01000 | $70.0 | $8.5 |
| Univ | | | | | | |
| AnacO8 | OB/GYN | 2500 | 2500 | 0.01000 | $25.0 | $8.5 |

This example is simplified to show Gross Keystrokes entered by each data entry operator, but the system may accommodate gross versus net keystroke calculations as well as a document per hour metric for data entry. A sample for scanning throughput is attached below:

| | | | | | Billing | Billing | Target |
|---|---|---|---|---|---|---|---|
| | | Images | Hours | Benchmk | Rate | Per | Labor |
| Code | Application | Tested | Tested | Image/Hr | Per Image | Hour | Rate |
| AAGH | Human Res | 25000 | 28 | 893 | 0.070 | $62.5 | $7.62 |
| AAPW | 1187's | 3000 | 3 | 1000 | 0.085 | $85.0 | $7.62 |
| Aberdeen | Loan Apps | 114000 | 164 | 695 | 0.157 | $109.1 | $7.62 |

Various tiers of incentive pay may be stored for each task. For example, in the scanning example above, for pure piece rate, the average production for AAGH human resource documents is 893 images per hour. Based on a three range piece rate, 0 through 893 images per hour would pay the employee 0.00854 per hour. If the employee averaged between 894 and 1000 images per hour, their piece rate may increase to 0.0102 per image an hour. And if they averaged 1001 or higher per hour, their piece rate per image could jump to 0.0122. As described above, other incentive structures are contemplated by the present invention. The target labor rate is the typical hourly rate that a certain type of skill would command in a particular local job market.

There is no cap on the pay rate. If a site chooses to pay on a tiered percentage of throughput for a task, then the calculation approach may be different. In this approach, each employee in a task is striving to be in the next higher quartile, for example. Using the scanning example above, the top 15% of the scanning staff may be paid $10 per hour, the next 25% may be paid $8.5 an hour, the next 40% may be paid $7.25 per hour, and the bottom 20% may be paid minimum wage. In addition to the performance plan, there may be a current quality data structure stored in the data repository 120 for each task. A structure for the throughput detraction impact for each type of category and the volume of each type of error allowed may be stored in data repository 120 as well.

Another aspect of the present invention may be a scheduling mechanism that allows performance calculations to be run at predetermined time intervals. Reports on employee rankings in a particular team or a particular task and employee scorecard reports (individualized by employee) may be generated and distributed as desired by each operating unit. Historical production and quality data may be utilized to schedule a team of employees, for example, for a new job. In addition, proposals for new jobs may be priced more accurately using the historical data.

To account for inexperience of a particular employee performing a particular task, a ramp factor manager (not illustrated) may be associated with employee management application 200. This ramp factor manager may provide for adjusting expected performance for a specific employee over time and may provide for effective dating and expiration so that a specific ramp factor with a defined start and end date may be assigned to an employee.

Performance calculator 206 may also permit managers or other suitable personnel to adjust for non-productive time, such as vacation time, training time, sick time, and uncontrolled down time. For example, a default for vacation time may be the average between base rate and last month's piece rate hourly equivalent.

Benchmarker 208 is a module that, in one embodiment, maintains baseline statistics for employees, job type, task type, and locations. The baseline statistics may include a scorecard of data points, and may provide a history of events identified as important to the evaluation process. Benchmarker 208 keeps data such as all the job types that an employee has worked on, the last date worked on, and a trend line of performance history, such as throughput and error rates. Statistical data generated by benchmarker 208 may be based on closed time periods. For recordkeeping purposes, this shields the historical data against later adjustments. Benchmarker 208 may also maintain statistics on training history, exceptional performance, and low performance for a particular employee. In addition, benchmarker 208 may also provide individual site performance histories so that site administrators can configure their own data points for benchmarking and report trending.

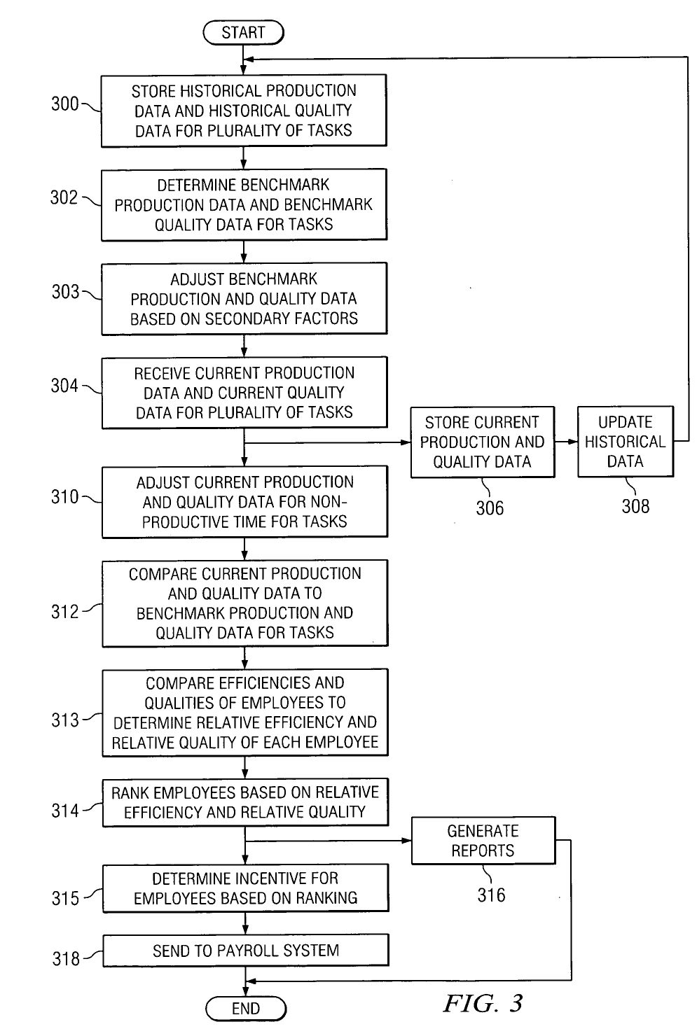

Reporter/data exporter 210 functions to provide a series of reports for performance analyses and employee pay. For example, reporter/data exporter 210 may generate and transmit approved incentive or payment data to a Time and Attendance system or payroll system for calculation of guaranteed minimum wage, overtime, and adjustments. For review of employees' performance, reporter/data exporter 210 may transmit historical reports to managers or supervisors in any suitable manner, such as email. In addition, reporter/data exporter 210 may function to rank employees by, for example, their relative efficiency or relative quality. This ranking may be on a per team basis, a per task basis, or other suitable basis. This is described in greater detail below in conjunction with FIGS. 3 and 4.

FIG. 3 is a flowchart illustrating an example method of evaluating and managing employees according to one embodiment of the present invention. The example method begins at step 300 where historical production data and historical quality data for a plurality of tasks is stored. As described above, this historical data may be stored in data repository 120 (FIG. 1) and may be received from any suitable source, such as directly from production module 128 via network 126. Based on at least some of this historical data, benchmark production data and benchmark quality data for the tests are determined at step 302. This benchmark data may be utilized to determine the efficiency of various employees. This benchmark data may be adjusted because of secondary factors, as indicated by step 303. These secondary factors may be such things as the difficulty of a particular job, the size of a particular job, the setup time for a particular task, and the stop time for a particular task. Other suitable secondary factors may be utilized to adjust the benchmark data. This adjustment may be manually input by a user of employee management application 200 or may be automatically determined by employee management application 200.

The example method continues at step 304 where current production data and current quality data for a plurality of tasks are received. This current production and quality data is stored in any suitable storage location, such as data repository 120, at step 306. It may also be utilized to update the historical data stored in data repository 120, as indicated by step 308. Since the current production quality data are for many employees performing a plurality of tasks, this current production and quality data may be adjusted, as indicated by step 310 to account for non-productive time for the tasks or for a particular employee. For example, non-productive time may include such things as vacation time, sick time, training time, and uncontrolled down time. This prevents the production rate, quality rate, and/or efficiency of a particular employee from being reported or calculated inaccurately.

This benchmark production data and quality data may be processed into a performance plan, an example of which is shown in FIG. 4 and described below. According to FIG. 4, a performance plan 400 is illustrated by a screen print 402. In the illustrated embodiment, performance plan 400 is in the form of a chart; however, other suitable forms for performance plan 400 are contemplated by the present invention. The performance plan 400 illustrated in FIG. 4 is for a particular task of a particular job. The rows of performance plan 400 illustrate a plurality of efficiencies 404 and the columns of performance plan 400 illustrate a plurality of quality standards 406. The rows of performance plan 400 may also illustrate a plurality of relative efficiencies and the columns of performance plan 400 may also illustrate a plurality of relative qualities in other embodiments. Efficiencies 404 represent how efficient a particular employee performs a particular task and the quality standards 406 illustrate the degree of quality that a particular employee exhibits on the particular task. Within any particular combination of efficiency and quality standard reveals an incentive 408 within the performance plan 400. For example, a particular employee having an efficiency of 130% and a quality standard of “silver” will have an incentive of 1.32, which in the illustrated embodiment represents an additional $1.32 over their base rate. Although the incentive illustrated in performance plan 400 illustrates an additional payment beyond the base rate for a particular employee, the present invention contemplates other suitable incentives to be associated with performance plan 400. Performance plans may also be adjusted on a periodic basis based on updated historical performance data.

Referring back to the flowchart of FIG. 3, the current production and quality data are compared to the benchmark production and quality data for the tasks at step 312. This results in the determination of efficiencies and qualities for each employee. Then, at step 313, the efficiencies and qualities for the employees are compared to determine the relative efficiency and relative quality of each employee. This allows a ranking or other suitable evaluation of employees based on the relative efficiency and/or relative quality, as indicated by step 314. This ranking is independent of the type of task performed, which may lead to a more fair assessment of a particular employee's skill.

Based on the ranking, an incentive for the employees may be determined, as indicated at step 314. For example, the performance plan 400 illustrated in FIG. 4 may be utilized to determine the incentive. Or another suitable incentive system may be utilized. The incentive is then sent to a payroll system, as indicated by step 318, so that the particular employee may be paid appropriately. The incentive may also be stored in a suitable storage location for recordkeeping purposes. Various reports may also be generated, as indicated by step 316, for any suitable purpose. For example, employee reviews may benefit from having reports generated by employee management application 200, or staffing decisions may also be made easier by having generated reports from employee management application 200. This then ends the example method outlined in FIG. 3.

Thus, employee management application 200 is a performance reporting tool that measures the productivity of many employees that are performing many different types of tasks. Employee management application 200 may be particularly suitable for large outsourcing companies that employee hundreds or even thousands of employees performing many different types of tasks on many different jobs. Responding to proposals and scheduling considerations may be made easier by employee management application 200. Employee management application 200 enables an outsourcing company or other suitable entity to become more profitable because the logistics of handling many different employees handling many different tasks at many different jobs is easier and more efficient.

Although embodiments of the invention and their advantages are described in detail, a person skilled in the art could make various alternations, additions, and omissions without departing from the spirit and scope of the present invention as defined by the appended claims.

What is claimed is:

1. A computerized method for evaluating and managing employees, comprising:
storing historical performance data for a plurality of tasks;
receiving, for a plurality of employees, current performance data for respective ones of the plurality of tasks;
determining benchmark performance data for each of the plurality of tasks based on at least some of the historical production data;
comparing the current performance data to the benchmark performance data for respective ones of the plurality of tasks to determine a performance value of each employee;
comparing the performance values of the employees to determine a relative performance value of each employee; and
determining an incentive for each employee based on the respective relative performance value of each employee.

2. The computerized method of claim 1 further comprising receiving the historical performance data from one or more production modules.

3. The computerized method of claim 1, further comprising storing the current performance data.

4. The computerized method of claim 1, further comprising updating the historical performance data based on the current performance data.

5. The computerized method of claim 1, further comprising:
ranking each employee based on the relative performance value of each employee; and
wherein determining the incentive comprises determining the incentive for each employee based on their ranking.

6. The computerized method of claim 1, further comprising scheduling a group of employees for a new job having at least some of the tasks based on the historical performance data.

7. The computerized method of claim 1, further comprising sending the incentive to a payroll module.

8. The computerized method of claim 1, further comprising receiving an adjustment for the current performance data.

9. The computerized method of claim 8, wherein the adjustment is for non-productive time selected from the group consisting of vacation time, sick time, training time, and uncontrolled down time.

10. The computerized method of claim 1, wherein the current performance data comprises an identity of the first employee, a job type for the first task, a task type for the first task, an elapsed time for the first task, and a unit of work produced.

11. Software for evaluating and managing employees, the software embodied in a computer readable medium and, when executed, operable to:
store historical performance data for a plurality of tasks;
receive, for a plurality of employees, current performance data for respective ones of the plurality of tasks;
determine benchmark performance data for each of the plurality of tasks based on at least some of the historical production data;
compare the current performance data to the benchmark performance data for respective ones of the plurality of tasks to determine a performance value of each employee;
compare the performance values of the employees to determine a relative performance value of each employee; and
determine an incentive for each employee based on the respective relative performance value of each employee.

12. The software of claim 11, further operable to receive the historical performance data from one or more production modules.

13. The software of claim 11, further operable to store the current performance data.

14. The software of claim 11, further operable to update the historical performance data based on the current performance data.

15. The software of claim 11, further operable to:
rank each employee based on the relative performance value of each employee; and
determine the incentive for each employee based on their ranking.

16. The software of claim 11, further operable to schedule a group of employees for a new job having at least some of the tasks based on the historical performance data.

17. The software of claim 11, further operable to send the incentive to a payroll module.

18. The software of claim 11, further operable to receive an adjustment for the current performance data.

19. The software of claim 18, wherein the adjustment is for non-productive time selected from the group consisting of vacation time, sick time, training time, and uncontrolled down time.

20. The software of claim 11, wherein the current performance data comprises an identity of the first employee, a job type for the first task, a task type for the first task, an elapsed time for the first task, and a unit of work produced.

21. A computerized method for evaluating and managing employees, comprising:
storing historical production data and historical quality data for a plurality of tasks;
determining benchmark production data and benchmark quality data for each of the plurality of tasks based on at least some of the historical production data and historical quality data;
receiving current production data and current quality data for a plurality of employees for respective ones of the plurality of tasks;
comparing the current production data to the benchmark production data for respective ones of the plurality of tasks to determine an efficiency of each employee;
comparing the current quality data to the benchmark quality data for respective ones of the plurality of tasks to determine a quality of each employee;
comparing the efficiencies of the employees to determine a relative efficiency of each employee;
comparing the qualities of the employees to determine a relative quality of each employee; and
determining an incentive for each employee based on the respective relative efficiency and the respective relative quality for each employee.

22. The computerized method of claim 21, further comprising receiving the historical production data from one or more production modules.

23. The computerized method of claim 21, further comprising storing the current production data and current quality data.

24. The computerized method of claim 21, further comprising updating the historical production data based on the current production data, and updating the historical quality data based on the current quality data.

25. The computerized method of claim 21, further comprising:
ranking each employee based on the relative efficiency and relative quality of each employee; and
wherein determining the incentive comprises determining the incentive for each employee based on their ranking.

26. The computerized method of claim 21, further comprising sending the incentive to a payroll module.

27. The computerized method of claim 21, wherein determining benchmark production data and benchmark quality data for each of the plurality of tasks is further based on secondary factors selected from the group consisting of task difficulty, task size, task set-up time, and task stop time.

28. The computerized method of claim 21, further comprising receiving an adjustment for the current production data.

29. The computerized method of claim 28, wherein the adjustment is for non-productive time selected from the group consisting of vacation time, sick time, training time, and uncontrolled down time.

30. The computerized method of claim 21, wherein the current production data comprises an identity of the first employee, a job type for the first task, a task type for the first task, an elapsed time for the first task, and a unit of work produced.

31. Software for evaluating and managing employees, the software embodied in a computer readable medium and, when executed, operable to:
store historical production data and historical quality data for a plurality of tasks;
determine benchmark production data and benchmark quality data for each of the plurality of tasks based on at least some of the historical production data and historical quality data;
receive current production data and current quality data for a plurality of employees for respective ones of the plurality of tasks;
compare the current production data to the benchmark production data for respective ones of the plurality of tasks to determine an efficiency of each employee;
compare the current quality data to the benchmark quality data for respective ones of the plurality of tasks to determine a quality of each employee;
compare the efficiencies of the employees to determine a relative efficiency of each employee;
compare the qualities of the employees to determine a relative quality of each employee; and
determine an incentive for each employee based on the relative efficiency and the relative quality for each employee.

32. The software of claim 31, further operable to receive the historical production data from one or more production modules.

33. The software of claim 31, further operable to store the current production data and current quality data.

34. The software of claim 31, further operable to update the historical production data based on the current production data, and update the historical quality data based on the current quality data.

35. The software of claim 31, further operable to:
rank each employee based on the relative efficiency and relative quality of each employee; and
determine the incentive for each employee based on their ranking.

36. The software of claim 31, further operable to send the incentive to a payroll module.

37. The software of claim 31, further operable to determine benchmark production data and benchmark quality data for each of the plurality of tasks is further based on secondary factors selected from the group consisting of task difficulty, task size, task set-up time, and task stop time.

38. The software of claim 31, further operable to receive an adjustment for the current production data.

39. The software of claim 38, wherein the adjustment is for non-productive time selected from the group consisting of vacation time, sick time, training time, and uncontrolled down time.

40. The software of claim 31, wherein the current production data comprises an identity of the first employee, a job type for the first task, a task type for the first task, an elapsed time for the first task, and a unit of work produced.
